(19) United States
(12) Patent Application Publication
(10) Pub. No.: US 2026/0182542 A1
(43) Pub. Date: Jul. 2, 2026

(54) PET TOY WITH FEATURES FOR DISPENSING A CONSUMABLE

(71) Applicant: 3TBrands, Inc., White Plains, NY (US)

(72) Inventors: Richard White, Castle Rock, CO (US); Jonathan Daugherty, Clayton, OH (US); Joel Kaplan, Katonah, NY (US)

(73) Assignee: 3TBrands, Inc., White Plains, NY (US)

(21) Appl. No.: 19/438,584

(22) Filed: Jan. 1, 2026

Related U.S. Application Data
(60) Provisional application No. 63/741,373, filed on Jan. 2, 2025.

(51) Int. Cl. A01K 15/02

(52) U.S. Cl. CPC A01K 15/025; A01K 15/0201

(57) ABSTRACT

A pet toy that is configured to optimize engagement and movement through accessibility of a consumable with the objective of providing comfort and soothing primarily through licking. The pet toy includes a base having a first chamber with an insert being positionable within the first chamber in either a first position or a second position. The insert defines a second chamber for holding the consumable. The pet toy also includes a cover that is coupled to the base and retains the insert in place in both the first and second positions of the insert. In the first position, an open end of the insert faces the cover and the consumable is dispensed through a top opening in the cover; and wherein in the second position, the open end of the insert faces the base and the consumable is dispensed through the at least one through hole formed in the base.

### CROSS REFERENCE TO RELATED APPLICATION

The present application claims priority to and the benefit of U.S. patent application Ser. No. 63/741,373, which is hereby incorporated by reference it its entirety.

### TECHNICAL FIELD

The present application relates to pet toys, and more particularly to a pet toy that has an ergonomic configuration to combine movement with the delivery of a liquid or solid consumable to satisfy the natural play instincts of an animal, encouraging engagement through the challenge of earning the liquid, paste, gel or solid consumable. The toy is designed to control the release and access to the consumable, while enhancing movement of the toy in a manner that entertains, and stimulates in a manner that that encourages activity that naturally leads to calming, comforting, and providing soothing benefits for the animal.

### BACKGROUND

Pet play is a natural ingredient to assuring pet health and wellness. Pet owners purchase toys to support play activities necessary for a healthy pet lifestyle. Fetch, Tug, Sensory, Comfort and Reward Play are core play styles that correspond to an animal's instinctual drives and that pet toys attempt to satisfy. The primary focus, regardless of age, breed, and size is to satisfy the dog's natural instincts whether through interactive or independent or comfort pet play. In addition to satisfying an animal's needs, Pet Parents seek toys that can help to satisfy their need for a toy that will provide a safe, controlled distraction that occupies their pet for an extended period of time to distract the pet from behavior that is destructive or distracting: from barking, jumping, chewing objects, etc., and also to occupy and soothe them to minimize separation anxiety when the pet parent is not able to be in proximity to the pet. They also look for toys that they can combine with treats of various types to reward both encouraging play and reward for that play activity.

Any well-designed dog toy uses some combination of materials, form, shape, structure, movement, noise, scent and or reward to attract interest that can engage the dog in play and that the pet parent finds fulfilling in caring for their dog. Form and function that consider the dog's anatomical and physiology are important considerations in the design, and choice of materials, especially as it relates to chew, reward, and enrichment toys.

Dogs typically seek the companionship of their pet family. Interactive play, such as tug and fetch, has a high level of attraction for the pet due to the shared nature of the experience so the role of the toy is central to the activity, but not the primary driver of keeping the dog's engagement. Independent dog play, where the dog must be self-entertaining, is a more challenging play experience as the absence of pet parent participation makes the toy central not only to the activity, but to creating the stimuli to attract and keep the dog's attention.

Independent play is a major objective of today's pet parents pet toy purchases as they often need time when home when they are not interrupted by their dog. They seek toys for their pets that provide a play experience that engages, comforts and soothes to minimize stress and anxiety of their pet, especially with they are away from their pet.

Developing toys that can satisfy independent play are often characterized by plush toys that hopefully become favorites that the dog does not chew, but carries and keeps with them in passive activity; chew toys where they are actively engaged in chewing; and reward toys which require the dog to have some play engagement to activate their ability to gain a consumable “reward.”

With passive play and chew toys, the scent, taste or stimuli that gains the dog's attention often wanes fairly quickly, lacking the time of engagement required to calm and soothe, leaving the dog looking for a new activity. Reward toys offer the greatest opportunity for engaging independent play as food or a consumable is always an attraction where the dog is incentivized to play with the toy to yield a treat that “rewards” them. These types of toys earn engagement by requiring the dog to figure out through play how to access the treat either by maneuvering the treat to lick or chew, or to have the toy release or distribute the consumable treat. The level of and length of engagement is in proportion to the time it takes to consume all the “rewards” or treats. Typically treat dispensing toys involve cavities that hold and release hard treats that are eaten and some may have simple surface areas to apply topical spreads. Some have surface areas designed to apply topical spreads and others have a cut or cup-like cavity for liquids that can be licked. If there is a hard treat that is exposed, it could be licked, but often if it is accessible where it is chewed where pieces of the treat break off from the original formed treat reducing time for engagement.

While engagement time for these types of toys is often longer than other independent play toys, the actual time is typically still not able to fully satisfy the ability to achieve calming and soothing. In this regard, spreads are more effective as they require licking, which is a slower form of consumption, and physiologically a more soothing form of activity for the dog, however, topically applied, there is no way to meter the dog's rate of consumption.

Licking is fundamental to dog wellness. Taste is an essential sense in how dogs associate environments, establish relationships, stimulate and soothe. Licking is the activity that enables taste to function. How a dog licks, how the dog can lick, how long the dog licks is at the center of establishing relationships, confirming environments, gaining nourishment, providing mental stimulation, soothing and comforting by themselves. Each of these elements contributes to how dogs entertain themselves and reduce or relieve anxiety.

Reward toys that can enhance the dog's desire to lick, better advance the dog's desire to engage in the play activity, and in doing so stimulate and soothe in ways that contribute to the dog's wellbeing. It also accomplishes the pet parent's objectives for successful independent play, so the pet parent has their own uninterrupted time, the knowledge that their dog is distracted from destructive or disruptive behavior, and/or the peace of mind that their dog is happily engaged when they leave their dog alone at home.

Pet parents have a desire for a pet toy that can dispense different types of consumables, including liquids, semi-solids, solids, and spreads. Typically, this requires the pet parent to purchase several different types of toys as no one toy supports all these consumables. The presently disclosed pet toy achieves this objective.

While the present disclosure describes the pet toy with respect to being used by a dog, it will be appreciated that the pet toy can be used by other animals, such as cats, etc., and therefore, the contextual background commentary shall not limit the scope of the present disclosure.

### SUMMARY

A pet toy that is configured to support the controlled dispensing of a consumable through licking. The pet toy includes a base having a non-planar bottom surface to promote engagement through movement and the rocking of the base. The base has a first chamber defined therein that is open at the top of the base and there is at least one through hole formed in the non-planar bottom surface in at least one embodiment. This chamber is designed to accommodate treats or kibble that can be dispensed through the hole or an insert that is removably received within the first chamber, with the insert defining a second chamber for holding the consumable. The insert comprises a cup-shaped object defined by a curved wall and an insert side wall. The curved wall of the insert closes off the first chamber such that at least one through hole defines an entrance into the second chamber through which a consumable liquid can exit the second chamber and be dispensed. The second chamber is designed to accommodate solids, pastes or liquids. A shaped member, such as a ball, is at least partially disposed within the second chamber and is configured to move (e.g., rotate) for the purpose of transferring said liquid consumable. The pet toy includes a cover that is coupled to the base such that the cover abuts a top edge of the insert to retain the insert in place and to provide aa zone to support licking and pet play. The cover has a top opening to allow access to treats in the interior chamber and through which when used the shaped member may or may not protrude. The shaped member freely moves (rotates) relative to the insert and the cover to permit the consumable to be dispensed through the top opening. The cover is designed to extend the lickable surface area beyond the opening in the cover and shaped to accommodate residual liquid or for holding spreadable consumables.

In yet another embodiment and configuration, a pet toy that is configured to support the controlled dispensing of a consumable treat. The pet toy includes a base having a non-planar bottom surface to promote engagement through movement and the rocking of the base. The base has a first chamber defined therein that is open at the top of the base and there is at least one through hole formed in the non-planar bottom surface. An insert is removably received within the first chamber, with the insert defining a second chamber for holding the consumable. The insert comprises a cup-shaped object defined by a curved wall and an insert side wall. The curved wall of the insert closes off the first chamber such that the at least one through hole defines an entrance into the second chamber through which a consumable solid can exit the second chamber or be held within the chamber and be dispensed. This insert is positionable within the first chamber in either a first or second position. In the first position, an open end of the insert faces the cover and the consumable is dispensed through a top opening in the cover; and wherein in the second position, the open end of the insert faces the base and a closed end of the insert closes off the top opening of the cover and the consumable is dispensed through the at least one through hole formed in the base. When the insert is inverted (second position), it can trap solids that can distribute through the opening in the base and spreads can be applied to the inverted bottom of the insert which would be accessible for licking through the hole in the top cover. The cover is designed to extend the lickable surface area beyond the center opening through the cover and is shaped to accommodate holding spreadable treats.

### BRIEF DESCRIPTION OF THE DRAWING FIGURES

The disclosure can be more completely understood in consideration of the following detailed description of various embodiments of the disclosure, in connection with the accompanying drawings, in which:

FIG. 1 is a side perspective view of a pet toy in a fully assembled condition and in a first orientation;

FIG. 2 is a side elevation view thereof;

FIG. 3 is a top plan view thereof;

FIG. 4 is a bottom plan view thereof;

FIG. 5 is a cross-sectional view thereof;

FIG. 6 is a side perspective view of a cover of the pet toy;

FIG. 7 is a side elevation view thereof;

FIG. 8 is a top plan view thereof;

FIG. 9 is a bottom plan view thereof;

FIG. 10 is side perspective view of a base of the pet toy;

FIG. 11 is a side elevation view thereof;

FIG. 12 is a top plan view thereof;

FIG. 13 is a bottom plan view thereof;

FIG. 14 is a side perspective view of an insert of the pet toy;

FIG. 15 is a top plan view thereof;

FIG. 16 is a bottom plan view thereof;

FIG. 17 is a side elevation view thereof;

FIG. 18 is a side elevation view of a consumable delivery member such as a spherical-shaped member (ball) of the pet toy;

FIG. 19 is a cross-sectional view of a pet toy in a fully assembled condition and in a second orientation;

FIG. 20 is a cross-sectional view of a pet toy in a fully assembled condition and in a third orientation;

FIG. 21 is a top plan view thereof;

FIG. 22 is a bottom plan view thereof;

FIG. 23 is a side elevation view of an alternative ball;

FIG. 24 is a side and top perspective view of a base according to another embodiment;

FIG. 25 is a side elevation view thereof;

FIG. 26 is an exploded perspective view of a pet toy including the ball of FIG. 23 and the base of FIG. 24;

FIG. 27 is a top plan view of the pet toy of FIG. 26 in a fully assembled condition;

FIG. 28 is a cross-sectional view thereof;

FIG. 29 is an exploded perspective view of a pet toy including the base of FIG. 24 without the ball;

FIG. 30 is a top and side perspective view of the pet toy of FIG. 29;

FIG. 31 is a top plan view thereof;

FIG. 32 is a cross-sectional view thereof;

FIG. 33 is a cross-sectional view of a disposable consumable cup embodiment that comprises a disposable consumable cup that is attached to a cover;

FIG. 34 is a top plan view thereof;

FIG. 35 is a cross-sectional view of an alternative disposable consumable cup embodiment;

FIG. 36 is a perspective view thereof; and

FIG. 37 is a cross-sectional view of another alternative disposable consumable cup embodiment.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION OF CERTAIN EMBODIMENTS

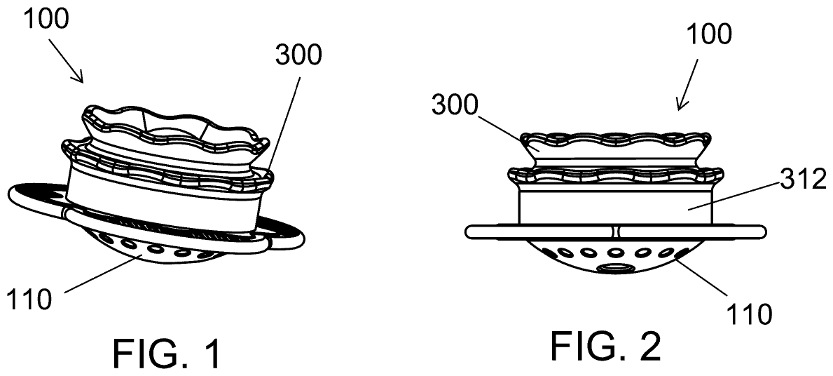

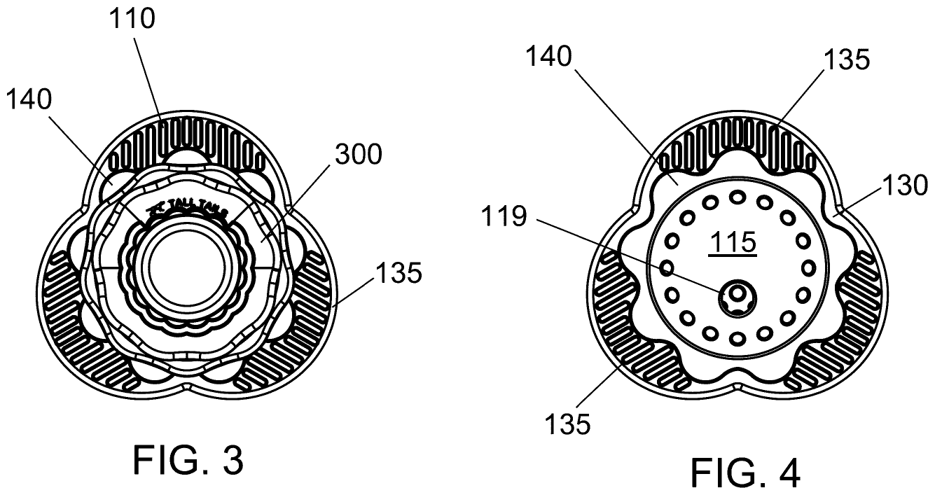

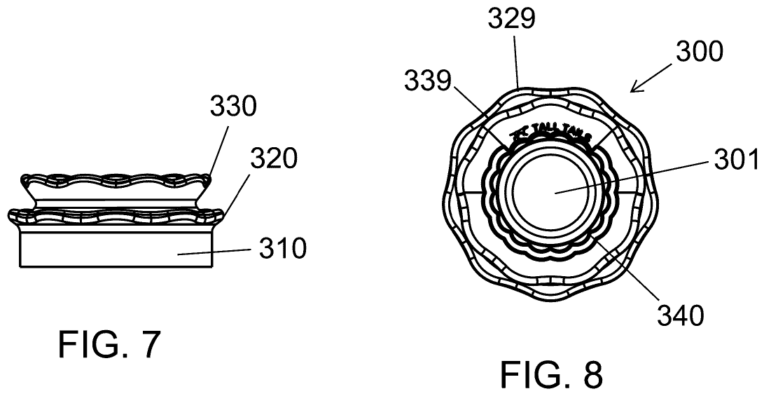

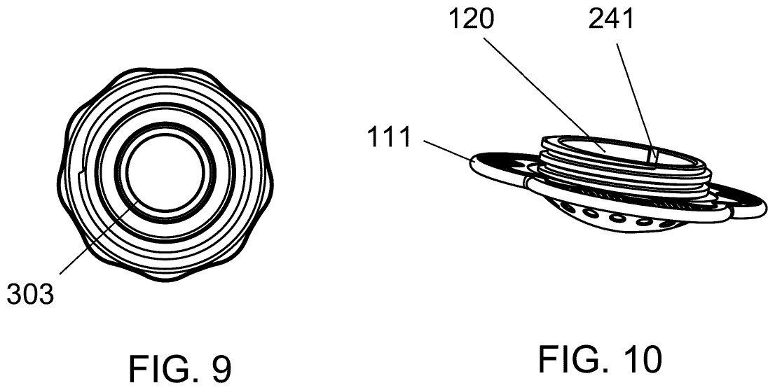

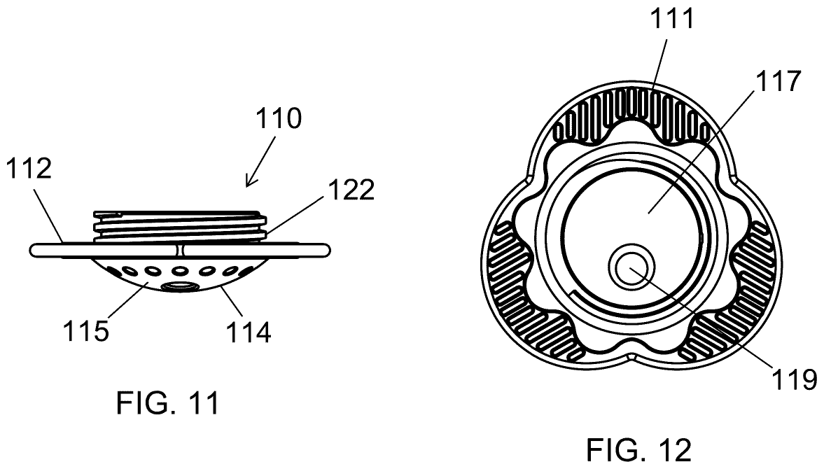

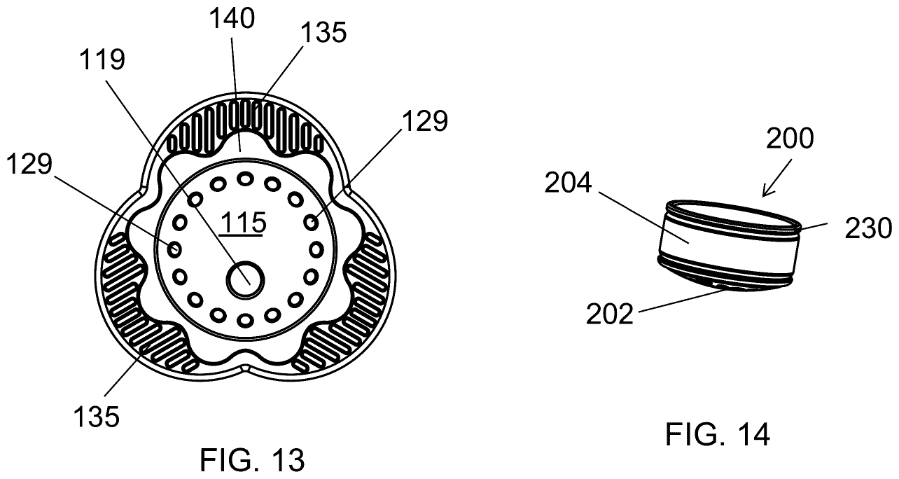

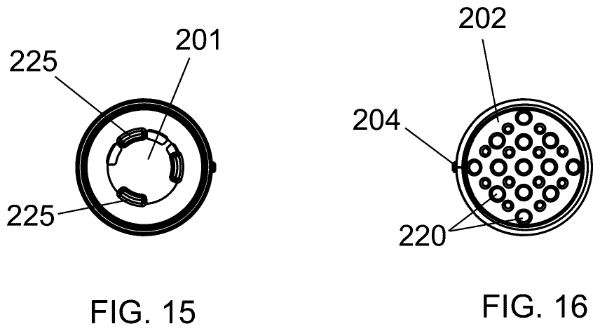

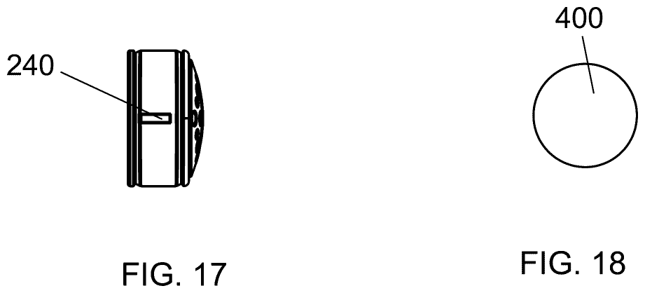

FIGS. 1-18 illustrate a pet toy 100 in accordance with one embodiment of the present disclosure. The pet toy 100 can also be characterized as being a pet lick toy in at least one embodiment, an apparatus for dispensing of consumables, etc. Broadly speaking the act of dispensing can take different forms including the presentation of a liquid consumable on a surface for consumption by the animal, the presentation and/or release of paste food, the release of solid food, etc. The pet toy 100 is formed of a number of parts that are configured to be assembled in one or more configurations to provide different experiences for the animal. Each of these parts is described separately and in more detail below. It will be appreciated that the liquid can have different a wide range of different viscosities so long as the liquid is deliverable using the disclosed parts.

### Base 110

More specifically, the pet toy 100 includes a base (member) 110 which is designed for placement on a ground surface, such as a floor or outdoor ground surface. The base 110 has an upper surface 112, an opposing bottom surface 114 and an outer peripheral edge 111.

The illustrated bottom surface 114, in at least one embodiment, is advantageously not planar but rather is a curved surface (e.g., convex surface) that is defined by a curved center portion 115 that defines the bottommost portion of the base 110. This construction of the base 110 provides a rocking motion to the pet toy 100 that advantageously allows the animal (dog) to change the angle of attack on the pet toy 100; however, as described below, the base 110 also includes features that prevent uncontrolled rolling of the toy. This rocking action provides for increased enjoyment and interaction between the animal and the pet toy increasing stimulation and engagement. The base design extensions not only prevent uncontrolled rolling of the toy, but a specific place for paw placement giving the animal the option to use the animal's paw to stabilize the pet toy at different angles to support licking.

However, it will be appreciated that the bottom surface 114 can be a planar (flat) surface which would result in the base 110 being more grounded and laying flat on the ground surface. It will be appreciated that this construction provides a different experience/different engagement for the animal. Thus, while the center portion of the base 110 is described as being a curved center portion 115, it will be understood that broadly it comprises the center portion of the base 110 and can be formed to lack curvature (e.g., be formed so as to be flat).

The base 110, and in particular, the curved center portion 115 defines a hollow space or first chamber 117 that can be centrally located in the base 110. This first chamber 117 has a concave shape and can be thought of as being a well. The floor of the first chamber 117 can be concave shaped or alternatively can be a flat surface and can include surface features. The curved center portion 115 has one or more through holes 119 formed therein. The illustrated curved center portion 115 has a single eccentric hole 119. This hole 119 provides direct communication to the first chamber 117. The hole 119 is shown as being circular shaped; however, it can equally have any number of other shapes and/or other sizes.

In addition, the bottom surface of the curved center portion 115 can include one or more types of first tactile features 129. For example, the first tactile features 129 can be in the form of a surface modifying feature. In the illustrated embodiment, the first tactile features 129 comprise a plurality of circular shaped recessed dimples that are arranged in a circular shaped pattern. While the first tactile features 129 are in the form of recessed structures, it will be appreciated that the features can be protruding features, such as bumps.

The first chamber 117 is also defined by an upper wall 120. The upper wall 120 is a continuously shaped structure that in the illustrated embodiment has a circular shape. The upper wall 120 includes outer threads 122 that are formed along its outer surface for joining the base 110 to another part, as described herein.

The base 110 includes an outer flange 130 that surrounds the curved center portion 115. It is this outer flange 130 that defines the outer peripheral edge 111 and can completely surround the curved center portion 115, with the upper wall 120 being located above the outer flange 130. The illustrated outer flange 130 has a scallop shape. More particularly, the outer flange 130 generally has three scalloped portions that represent flower petals surrounding the curved center portion 115. It will be appreciated that the outer flange 130 can equally have other shapes and appearances. The illustrated pet toy 100 generally has a lotus flower construction and appearance. As described herein, the outer flange 130 not only provides an aesthetic look but it also provides functionality in that the outer flange 130 provides a surface area that allows the animal to more effectively use its paws to secure and adjust the attach angle. As such the flower shape that is illustrated is merely one design for the toy's appearance and there are many more that are suitable.

As discussed herein, one or more of the parts can include surface modifying features. Broadly, surface modifying features comprise features that modify the surface of the part. For example, the surface modifying features can comprise tactile features, decorative features, indicia, etc. The surface modifying features can also be male structures or female structures.

As shown, the upper surface of the outer flange 130 can include one or more types of second tactile features 135. For example, the second tactile features 135 can be in the form of raised bumps, ribs, or ridges or recesses, such as recessed channels. In the illustrated embodiment, the second tactile features 135 comprise a plurality of recessed channels that are arranged in multiple areas and formed side-by-side. For example, the upper surface of each petal of the outer flange can include a distinct patch of second tactile features 135.

The base petals also comprise functional elements. For example, the base petals provide for paw zones to allow areas for the dog to stabilize the toy, as well as adjusting the attack angle, and has dimensions that minimizes the toy rolling over and the base petals and side petals on the base provide zones for spreadables or pastes to expand the consumable experience. In other words, a spreadable consumable can be spread over these areas and will stick thereto and be accessible for the dog while also providing paw space supporting how the dog can adjust their angle of attack for engaging with the toy and the related treat—solid, paste or liquid.

In other words, the outer flange 130 limits the degree of rocking motion since when a portion of the outer flange 130 strikes the ground, the pet toy is prevented from further movement (e.g., rolling) and flipping over, etc. This motion, as described herein, also changes the angle of attack for the pet toy. Once the paw is lifted off of the outer flange 130, the pet toy can wobble and stabilize and can rock back to a different position. The beauty of the present construction, in the illustrated embodiment, is this rocking motion that is created in response to the dog's ability to generate an action/reaction.

Around the upper wall 120, there can be a contoured section 140 that can have an unadorned top surface or can have surface features. For example, contoured section 140 can be a wave pattern (undulating pattern). The contoured section 140 is located between the upper wall 120 and the patches of second tactile features 135.

Due to the convex shape of the curved center portion 115 and the surrounding outer flange 130, the base 110 has a saucer shape.

The bottom surface 114 is thus defined by the curved center portion 115 and the bottom of the outer flange 130, while the top surface 112 is defined by the top edge of the upper wall 120 and the top of the outer flange 130.

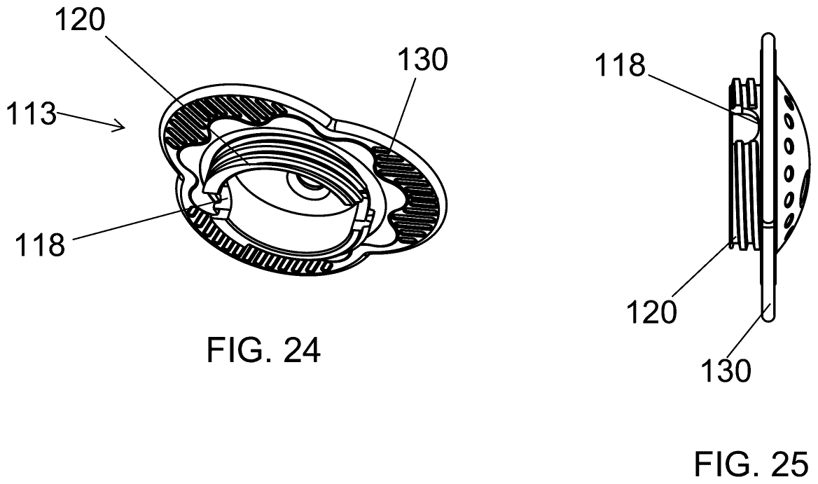

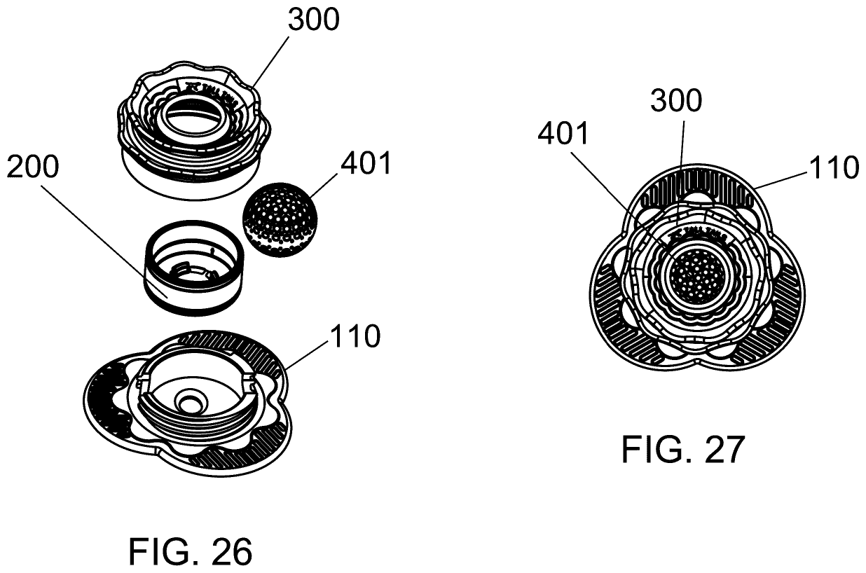

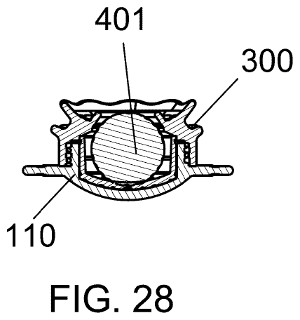

FIGS. 24-25 illustrate an alternative base 113 that is very similar to and includes most of the features of base 110 and therefore, like elements are numbered alike and the discussion of FIGS. 24-25 will focus only on the differences between the base 110 and the base 113. The base 113 includes the upper wall 120; however, instead of being a continuous wall as in the base 110, the upper wall 120 of the base 113 includes one or more notches 118 that are formed therein. Each notch 118 passes completely through the upper wall 120 and thus defines an entrance or passage into the first chamber 117. As shown in the figures, each notch 118 can have a U-shape that is open along the top edge of the upper wall 120. It will be appreciated that the size and/or shape of the notch 118 can differ from that illustrated. In the illustrated embodiment, the upper wall 120 includes two notches 118 that are formed 180 degrees apart. As described herein, the notches 118 allow for easy removal of an object placed therein (such as the insert 200 described below), either by providing direct access to the sides of the inserted object or by acting as a hinge that allows the base 113 to be flexed in the direction of the curved base with the result of expulsion of the inserted object (e.g., insert 200). This hinge structure can also assist in placing the insert within the chamber since the user can flex the base at the hinge to “open up” the chamber and provide easier insertion of the insert 200. Once inserted, the user then releases the hinged base.

### Insert 200

The pet toy 100 also includes an insert 200 that is configured to be received within the first chamber 117 of the base member 110. The insert 200 has a cup shape and is defined by a closed bottom wall 202 and an upstanding side wall 204, with the top of the insert 200 being open. The insert 200 thus defines a second chamber 201 between the side wall 204. The bottom wall 202 can have a concave shape as viewed from the inside and convex from the outside; however, a flat design (planar bottom wall) is possible as well. This shape of the curved bottom wall 202 is complementary to the concave shape of the curved center portion 115 to allow at least a section of the insert 200 to sit flush on or in stable contact with the curved center portion 115. Similarly, the dimensions of the insert 200 are such that the side wall 204 seats flush against the inner surface of the upper wall 120. The insert 200 is thus intended and designed to fit snug within the base 110.

As shown in the figures, a bottom surface of the insert 200 can include third tactile features 220. In the illustrated embodiment, the third tactile features 220 can be in the form of dimples (craters) that are spread across the bottom surface. It will be appreciated that the third tactile features 220 can be in the form of one or more protrusions, such as rounded bumps. In addition, the inner surface of the floor of the insert 200 can include one or more and preferably a plurality of protrusions 225 that protrude upwardly. The plurality of protrusions 225 can be in the form of discrete arcuate shaped sections that together define an arcuate shape with an open space in the center thereof. The plurality of protrusions 225 define a support structure for the (spherical) shaped member as described below; however, additional protrusions or depressions can be added to increase the holding power of the treat material while also providing additional tactile surface exploration by the animal's tongue.

Along the outer surface of the side wall 204, there can be certain functional features to assist the user in using the pet toy. For example, the outer surface of the side wall 204 can include a groove 230 that can be a continuous groove as shown or can be two or more interrupted grooves. This groove 230 provides a means for easily removing the insert 200 from the base 110. More specifically, the user places his/her fingertip within the groove 230 to easily lift the insert 200 out of the base 110. The top edge of the insert 200 sits above the upper wall 120.

The outer surface of the side wall 204 can also include a guide or indexing (key) feature to ensure that the insert 200 can only be inserted in one way. For example, the guide feature can be a guide rail 240 that is formed along the side wall 204. The illustrated guide rail 240 is oriented vertically along the outer surface of the side wall 204. The guide rail 240 is configured to be received within a locating slot 241 that is formed along the inner surface of the upper wall 120, thereby coupling the insert 200 to the upper wall 120. The guide rail 240 is an indexing (key) feature since the insert 200 can only be inserted one way into the base 110 in which the guide rail 240 is received in the locating slot 241 to permit full insertion of the insert 200 into the base 110. This indexing feature thus acts as a key that prevents clockwise or counterclockwise rotation of the insert 200 within the base 110. However, it will be appreciated that, as shown in other embodiments, this guide feature is optional and can be eliminated. In other words, the guide rail 240 and the locking slot 241 can both be eliminated.

Referring back to FIGS. 24-25, each notch 118 is intended to provide access to the insert 200 that is disposed within the first chamber 117. As discussed herein, the insert 200 is a removable part that holds the consumable and thus, the one or more notches 118 allow a user to more easily grasp the insert 200 for removal thereof. For example, the user can place a finger and thumb through the two opposing notches 118 to contact and grasp the insert 200 for removal thereof. The insert 200 is grasped and then lifted out of the first chamber 117. Moreover, as mentioned above, the notches 118 create a flexible “hinge” to make for easy expulsion of the insert 200 as well as easy insertion.

### Cover 300

The pet toy 100 further includes a top member or cover 300 that is configured to be coupled to the base 110 and to retain the insert 200 within the pet toy 100. As described herein and illustrated in the figures, the cover 300 can be threadingly coupled to the base 110.

The cover 300 is a hollow structure with a top opening 301 and an opposite bottom opening 303 for receiving the insert 200 and the base 110. A chamber/open space 305 is created and is defined by the hollow interior of the insert 200 and by the hollow interior of the cover 300. Entrance to the chamber 305 is thus through the top opening 301 of the cover 300 with an upper region of the chamber 305 defined by the cover 300 and a lower region of the chamber 305 defined by the insert 200.

The cover 300 has a bottom section 310, intermediate section 320, and a top section 330. The bottom section 310 is defined by a side wall 312 with an inner surface of the side wall 312 having inner threads 314 that mate with the outer threads 122. In other words, the cover 300 is screwed on top of the upper wall 120 resulting in the cover 300 (e.g., the bottom section 310) surrounding the upper wall 120. The outer surface of the bottom section 310 can be unadorned as shown or can be adorned.

The intermediate section 320 can represent the section of the cover 300 that contacts and retains the insert 200. The inner surface/inner face of the intermediate section 320 seats against the top edge of the insert 200. The intermediate section 320 can have a contoured outer surface. In the illustrated embodiment, the intermediate section 320 can have a first flower appearance defined by a first flower shaped projection 329. Similarly, the top section 330 can have a second flower appearance defined by a second flower shaped projection 339. The first flower shaped projection 329 and the second flower shaped projection 339 can have similar appearances or different appearances and the size can be the same, similar, or different.

The top section 330 has an opening defining portion 332 that has a curved inner surface that is also tapered inward toward the center of the top opening of the cover 300. In other words, a distance between the top of the opening defining portion 332 is less than a distance between the bottom of the opening defining portion 332. The opening defining portion 332 can be considered to be a collar (annular shaped) which breaks the slope of the top surface structure of the cover and helps to define the trough structure described herein that can be used to retain or hold one consumable. Between the opening defining portion 332 and the second flower shaped projection 339, there is a valley 340 that comprises the trough. As shown, the valley (trough) is thus located between the collar and the outer perimeter wall (outer perimeter edge) of the cover (with the outer perimeter wall having a greater height than the collar in the illustrated embodiment). Within the valley 340, the outer, top surface of the top section 330 can include decorative features, such as embossed or raised patterns, or debossed structures, or both. The decorative features are functional as well as decorative as in these decorative features, spreadable treats can be used and the features hold the spreadable and lengthen the time for the spreadable to be consumed. The valley 340 advantageously surrounds the opening and is able to capture and hold food. This area (valley 340) thus provides an area not only to hold food but also provides an additional pet interaction area that the animal can engage during play.

It will thus be appreciated that the cover 300 is designed so that when it is screwed onto the base 110 to a snug position, the intermediate section 320 is lowered into contact with the top edge of the insert 200, thereby retaining the insert 200 in its desired position (one in which the insert 200 is fully seated and in contact with the top surface of the curved center portion 115 which defines the floor of the center cavity of the base 110. However, in other embodiment, the top surface of the cover 300 does not include the slope and trough (valley) construction but instead only includes the collar design as the opening defining portion 332.

### Consumable Delivery Member

The pet toy 100 also includes a consumable delivery member 400 that is configured to be received within the hollow interior space of the insert 200 and is captured below the cover 300. The consumable delivery member can take any number of different forms so long as it is configured to move under a licking action and transfer the consumable held within the insert 200. The consumable delivery member can take the form of a spherical shaped member/object 400, such as a ball, that can freely move under the (licking) action of the animal and more particularly, can freely rotate within the insert 200 on one or more of the sphere's axes below the cover 300. The consumable delivery member thus freely rotates within the insert 200 and within the top opening 301 of the cover 300. When the consumable delivery member 400 sits within the insert 200, the consumable delivery member 400 sits on and rotates relative to the plurality of protrusions 225. For ease of illustration, the consumable delivery member 400 will be described as being a spherical shaped member (i.e., a ball 400); however, as also described herein, it can take other forms.

A small space is formed between the opening defining portion 332 and the ball 400. This space allows for the consumable located along the outer (spherical) surface of the ball to freely pass through to allow direct contact by the animal's tongue and consumption by the animal. This operation is discussed in more detail herein but generally the hollow interior of the insert 200 defines a well that contains the consumable and at least the bottom portion of the ball is disposed within the well and therefore as the ball rotates, the outer surface of the ball is coated with the consumable. The well thus provides a source of the consumable and the rotation of the ball within the well ensures a continuous wetting action for the ball.

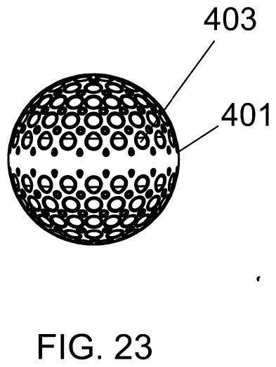

In the embodiment in FIG. 18, the ball 400 has a solid outer surface. The ball 400 can be a hollow or solid ball but the outer surface is completely continuous and can be smooth in nature as shown. FIG. 23 illustrates an alternative ball 401 construction in which the ball 401 includes a plurality of dimples 403. It will be appreciated that the number of dimples 403 can vary and/or the pattern of the dimples 403 can vary. The dimples 403 provide a contoured surface that permits additional retention of the consumable since the consumable enters and is retained within the dimples (concave shaped). In yet another embodiment, the ball can be a textured ball other than a dimpled ball. By texturing the ball, the ball pulls up liquid or other matter from the insert 200 (cup) when the animal licks the ball.

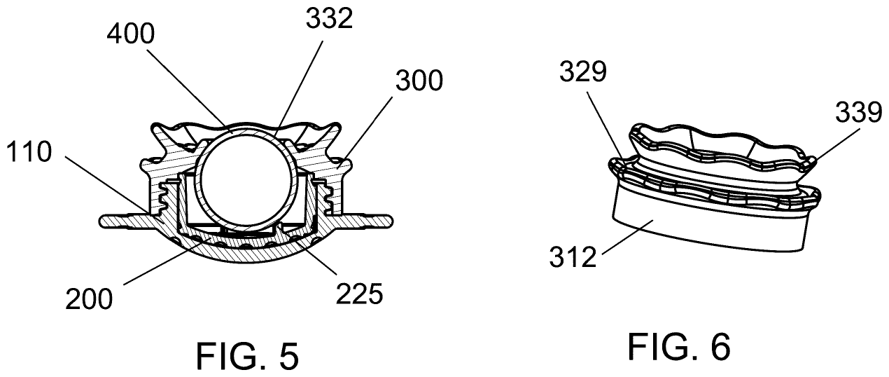

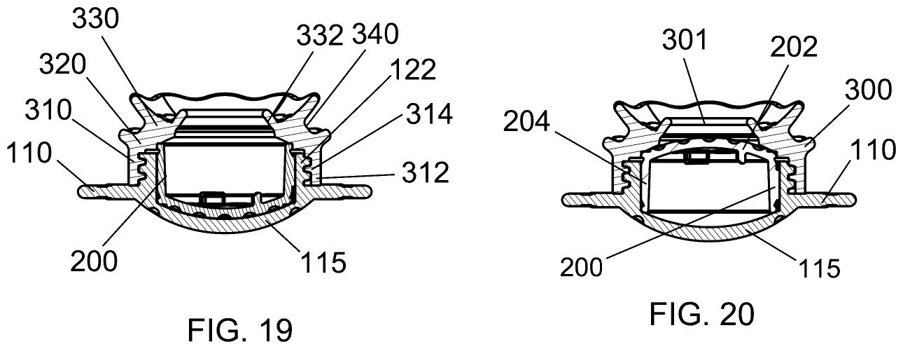

In an alternative embodiment shown in FIG. 19, the pet toy has the configuration of FIG. 5 but the ball 400 is omitted. With the ball 400 omitted, the open end of the insert 200 is completely open and accessible. In this alternative embodiment, the spherical, cylindrical or disc-shaped consumable member/object, pastes, spreads, wet or dry food, kibble or treats can sit within the insert 200 on one or more of the spheres of axis below the cover 300, where the consumable is accessible within the top opening 301 of the cover 300. To access the object, the animal's tongue can be inserted within the opening. In this alternative embodiment, the valley 140 can also capture the consumable that is within the insert and the animal can engage with and contact the consumable in the valley. In addition, the tactile features in the valley provide tactile feedback to the animal.

In yet another embodiment, the ball comprises a hollow textured ball that contains smaller shapes of material that would create noise (e.g., white noise) when licked by the animal. As the ball rolls, the material within the ball rolls and creates said noise.

The cover 300 provides several important features in that the cover 300 is the part that captures and retains both the insert 200 and the ball 400 in place within the pet toy 100, while freely permitting delivery of the consumable. In addition, the construction of the cover 300 is such that the when the cover 300 is upside down as when the entire pet toy 100 is turned upside down, the cover 300 prevents the spherical shaped member 400 (the ball) from touching the ground surface and minimizes the outflow of any liquid consumable in the well or the solid treat ball or disc.

The cover 300 is shaped to create a lick zone by providing an ergonomically curved surface area to support tongue contact for a range of snout/nose shapes of the animal through the licking activity. In addition, this surface area is designed to accommodate pastes or spreads to further enhance licking engagement. As mentioned herein, the collar of the cover 300 functions to enhance the licking experience by defining an area for the consumable and thus, supports the licking experience.

In yet another embodiment, the shaped member can have a shape other than a ball. In particular, instead of a ball, a rotatable member can be used that functions in the same way as the ball 400 in that the rotatable member functions as the consumable delivery member that is configured to be received within the hollow interior space of the insert 200 and is captured below the cover 300. For example, the consumable delivery member can take the form of a rotatable tube or it can have a pill shape. In the case of a tube, the side wall of the insert 200 can have one or more retaining elements that hold posts at the ends of the tube that permit free rotation of the tube within the insert. Accordingly, it will be appreciated that the consumable delivery member can take many different forms (shapes and sizes) so long as it can freely move and deliver the consumable.

In yet another embodiment, the consumable delivery member 400, such as the ball, can comprise a consumable (e.g., made from animal or vegetable material). In this case, repeated licking by the animal will erode the consumable delivery member 400 over time. The consumable ball will still deliver the consumable (liquid) as described herein. In the event, the consumable delivery member 400 is itself a consumable, it will preferably be a solid structure as opposed to the hollow ball in FIG. 5.

### Alternative Arrangement of Parts

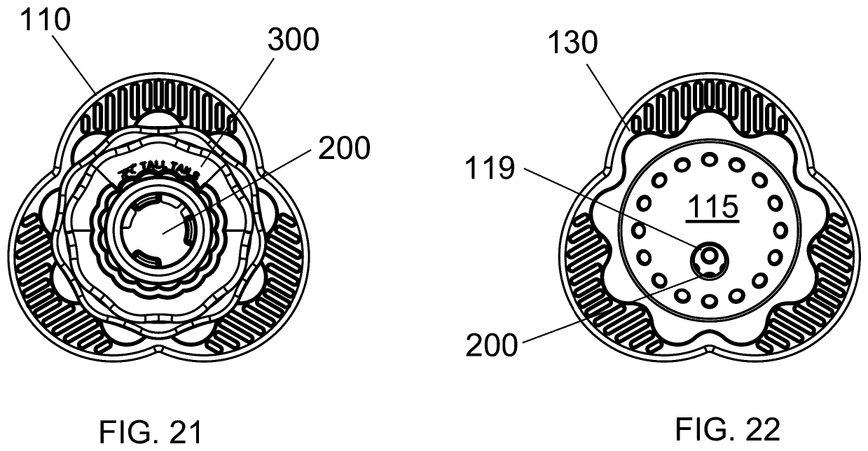

FIGS. 20-21 illustrates an alternative arrangement of the parts of the pet toy 100 to provide an entirely different experience for the animal. In this alternative arrangement of parts, the pet toy 100 is configured to hold and dispense pellet-like edibles as opposed to a liquid or solid consumable as in the previous embodiment.

In this alternative arrangement, in the fully assembled position, the insert 200 is inverted from its orientation in FIG. 5. In other words, the open interior space (the well) of the insert 200 faces downward as opposed to upward in the previous embodiment.

First, the insert 200 is filed with pellet-like edibles and is then mated to the base 110 which results in the pellet-like edibles being disposed along the curved center portion 115 within the first chamber 117 (sheet 5). As mentioned, the curved center portion 115 has one or more through holes 119 formed therein and in this embodiment, the one or more through holes 119 are not covered up by the bottom wall of the insert 200 but instead, the one or more through holes 119 are in direct communication with the open interior space (the well) of the insert 200. Since the one or more through holes 119 are now open due to the inverted orientation of the insert 200, the pellet-like edible in the insert 200 can be dispensed through the one or more through holes 119 to the animal.

In this inverted position of the insert 200, the intermediate section of the cover 200 makes contact with the bottom wall of the insert 200 which in this inverted orientation faces upward. The top edge of the insert 200 sits against the curved center portion 115. The closed bottom wall of the insert 200 faces upward and extends across the top opening 301 of the cover 300. This engagement is shown best in the cross-sectional view in FIG. 20.

The cover 300 provides several important features in that the cover 300 is the part that captures and retains the inverted insert 200 within the pet toy 100, to support the distribution and delivery of the consumable. In addition, the construction of the cover 300 is such that the when the insert 200 is upside down, the top opening 301 provides a target zone for spreadable edibles that can be placed on the surface of the insert 200.

The cover 300 is shaped to create a lick zone by providing an ergonomically curved surface area to support tongue contact for a range of snout/nose shapes of the animal through the licking activity. In addition, this surface area is designed to accommodate edible pastes or spreads to further enhance licking engagement.

In this embodiment, the consumable delivery member 400 is not used.

### Consumable

Any number of different types of consumables can be used with the pet toy 100. In certain embodiments, the consumable can be a liquid consumable, such water or a flavored liquid a nutrient enriched liquid, a dental hygiene liquid, broth, milks, etc.

In other embodiments, the consumable can be a paste-like, gel or spreadable material.

In other embodiments, the consumable can be a solid material for delivery in the alternative arrangement of parts.

It will therefore be appreciated that the disclosed pet toy can be converted into different configurations that provide different experiences to the animal. For example, the pet toy can be placed in the following configurations:
A—Top Opening Ball with Liquid (Consumables);
B—Top Opening Solid Consumables—Solid Ball—Solid Disc—Wet Food—Kibble—Treats;
C—Bottom Opening—Distribute Treats—Kibble;
D—Cover 300 surface area to create a lick zone the importance of (a) the lick zone to maximize tongue contact to extend and to enhance the licking experience and (b) ergonomic considerations to support various dog physiology-nose work-different snout anatomies;
E—Cover 300 surface to provide zone (e.g., valley 140) for spreadables or pastes to expand consumable experiences;
D—Base petals for paw zones to allow areas for the dog to stabilize the toy; and
E—Base petals and side petals on the base to provide zones for spreadables or pastes to expand the consumable experience.

It will also be understood, that as described herein, each of the parts described herein, such as the base, cover, insert, and consumable delivery member can be a consumable itself in that the respective part can be formed from animal and/or vegetable material and is thus suitable for consumption by the animal.

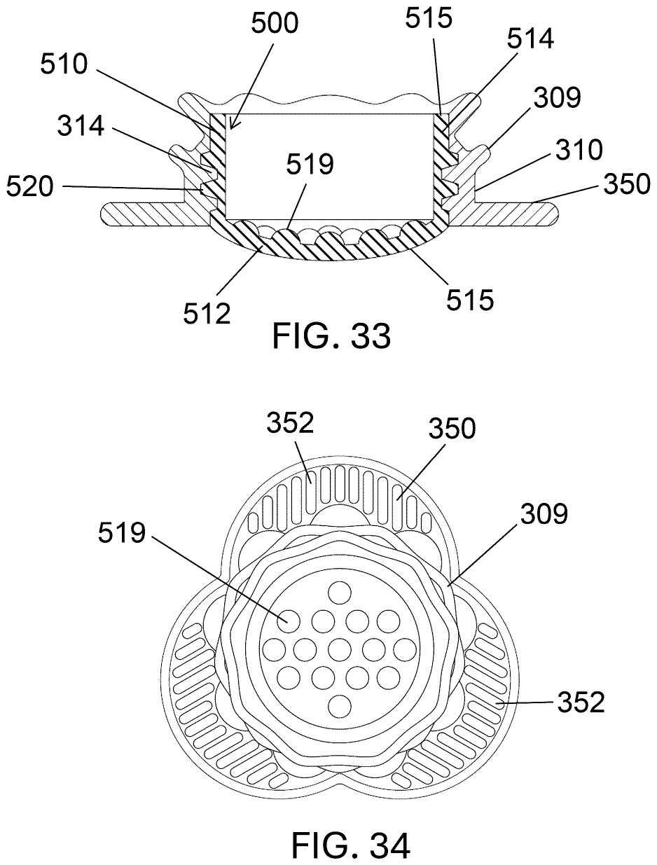

### Disposable Consumable Cup (FIGS. 33-37)

In yet another embodiment, the pet toy described herein can be transformed into another pet toy product. In particular, the cover 300 or cover 309 can be used in combination with a disposable consumable cup 500.

The consumable cup 500 includes a container or receptable 510 that contains the consumable. The container 510 can be formed of any number of suitable materials, including but not limited to plastics. Alternatively, the container 510 can be formed of a paper product, such as a paper product that is treated to have a thin plastic internal liner or layer that contacts the consumable. The container 510 can be semi-rigid or it can be substantially rigid. The container 510 has a bottom 512 and a side wall 514. The container 510 is open along its top which is defined by a top edge 515.

Within the inside of the container 510 there is surface texture. For example, the bottom 512 can include surface texture, such as recesses and/or raised features that facilitate the retention of the consumable, thereby requiring additional effort and engagement from the pet to lick up all of the consumable. Optionally, the side wall 514 can include surface texture, such as recesses and/or raised sections. In the illustrated embodiment, the bottom 512 can include raised bumps 519.

Unlike traditional food cup products, the container 510 does not have a planar bottom but instead the bottom 512 has a non-planar bottom surface 515. For example, the bottom 512 can have a curved surface as shown to promote engagement through movement and the rocking of the container 510, which in this embodiment represents a ground contacting surface. However, in alternative embodiments, the bottom 512 can be flat (planar).

The container 510 is sealed with a foil or plastic lid 530. Prior to use, the foil lid 530 is removed by peeling it off or otherwise rupturing it.

In one embodiment, the side wall 514 includes external threads 520 formed at or proximate to the top edge of the container.

The container 510 holds a consumable such as those described hereinbefore. In one embodiment, the container 510 holds a paste-like pet food product.

As mentioned, in this embodiment, there are two parts that are combined, namely, the disposable consumable cup 500 and the cover 300 or 309. The other parts, such as the base, insert and ball are not used. The container 510 and cover 300, 309 are configured to mate together in a secure relationship. In other words,, the container 510 and the cover 300, 309 are configured to be detachably coupled to one another. Any number of different conventional coupling or fastening techniques can be used. In one embodiment, the disposable consumable cup 500 is threadingly attached to the cover 300, 309 or in another embodiment, the two parts can be coupled with a releasable snap-fit.

In the figures, a threaded connection is shown in that the external threads 520 of the container 510 can engage the inner threads 314 of the cover 300 to connect the two parts together. It is also possible for the cover 300, 309 to have a dual (double) threaded structure in that a first set of threads is for use with connecting the cover 300, 309 to the container 510 and a second set for connecting the cover 300, 309 to the base 110.

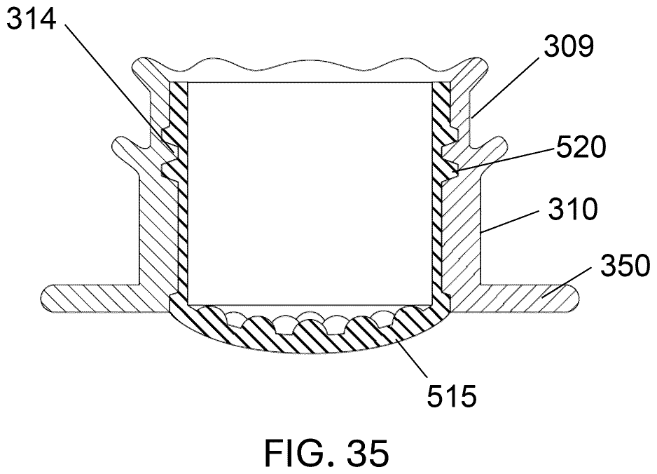

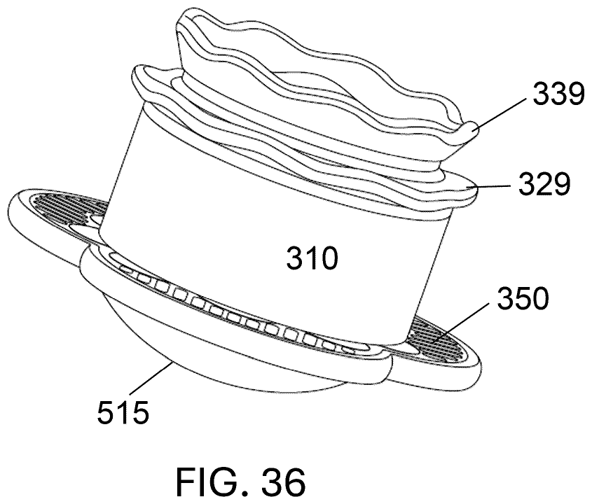

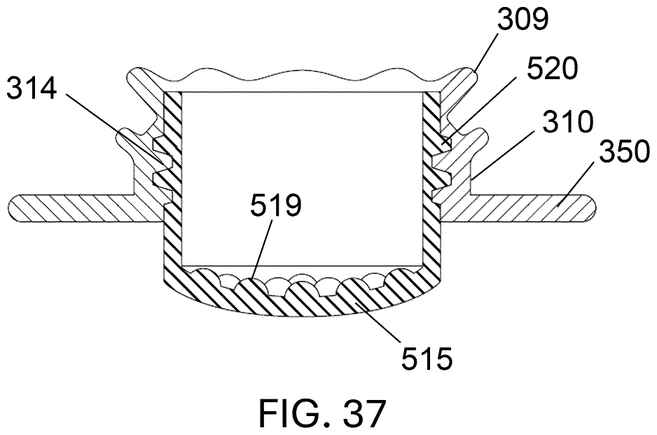

When the container 510 is attached to the cover 300, 309, the container 510 extends below the bottom edge of the cover 300, 309 and thus, defines the ground contact surface. The container 510 can have a height that is greater than the height of the cover 300, 309 (FIG. 37); however, it will be appreciated that the height of the container 510 can be the same, similar or less than the height of the cover 300, 309 so long as the container 510 extends below the cover 300, 309 to provide a ground contacting surface. FIGS. 35-36 shows a taller structure in which the bottom surface 515 is closer than the underside of the outer flange 350 then the embodiment shown in FIG. 37 in which the bottom surface 515 is further away from the underside of the outer flange 350. In the embodiment of FIG. 37, it will also be appreciated that the outer flange 350 has a greater width (diameter) than the embodiment shown in FIG. 35. In FIG. 37, since the container 510 extends further below the bottom of the cover 300, 309, the width of the outer flange 350 is increased to allow a rocking motion but also to allow the outer flange 350 to contact the ground to provide a suitable angle of attack for the animal to access the contents of the container 510.

The cover 309 is similar to the cover 300; however, the cover 309 has a slightly different structure that is designed in view of this alternative embodiment. More specifically, the cover 309 includes an outer flange 350 that surrounds the bottom section 310. It is this outer flange 350 that defines the outer peripheral edge of the cover 309 and can completely surround the bottom section 310. The illustrated outer flange 350 has a scallop shape. More particularly, the outer flange 350 generally has three scalloped portions that represent flower petals surrounding the bottom section 310. It will be appreciated that the outer flange 350 can equally have other shapes and appearances. As with the cover 300, the outer flange 350 defines paw engaging surfaces (pads) that allow the animal to stabilize the pet toy during use and in particular, during an active play or feeding session (e.g., the paw is placed on the paw engaging surface to hold down the pet toy). The outer flange 350 alternatively also provides a surface that permits the pet toy to be flipped over by lifting upward on the outer flange 350.

As shown, the upper surface of the outer flange 350 can include one or more types of tactile features. For example, the tactile features can be in the form of raised bumps, ribs, or ridges or, as shown, can be in the form of recessed channels 352, recesses, etc. In the illustrated embodiment, the tactile features comprise a plurality of recessed channels that are arranged in multiple areas and formed side-by-side.

In yet another embodiment, a modified base can also be used with the above combination in that the base can include a center opening open along the bottom thereof to permit passage of the disposable consumable cup 500. The bottom of the cup 500 can be designed to form a continuous bottom surface with the bottom surface of the base or the bottom surface of the cup 500 can extend below the bottom of the base.

### Scent

It will also be appreciated that one or more parts of the pet toy can be scented. The addition of one or more scents to the material(s), that comprise the toy, enhances the engagement and play experience. Conventional techniques can be used to impart the scent(s) to the materials. For example, in the case of plastics, fragrances can be added as a “masterbatch” (concentrated pellets) during plastic manufacturing.

### Surface Texture

In yet another aspect, texturing can be provided to one or more surfaces of one or more of the toy parts to enhance the engagement and play experience from exploration of textures by the animal's tongue. Texturing creates sensations on the dog's tongue when licking that provide mental stimulation. For example, the texturing can be configured to enable the treat material to better adhere to the toy for licking by the animal (i.e., the consumable is captured within the surface texture features). The figures illustrate texturing on various different surfaces of the pet toy.

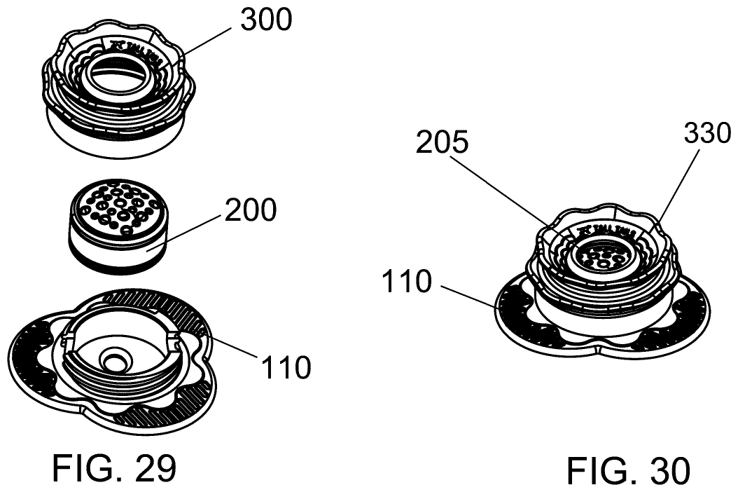

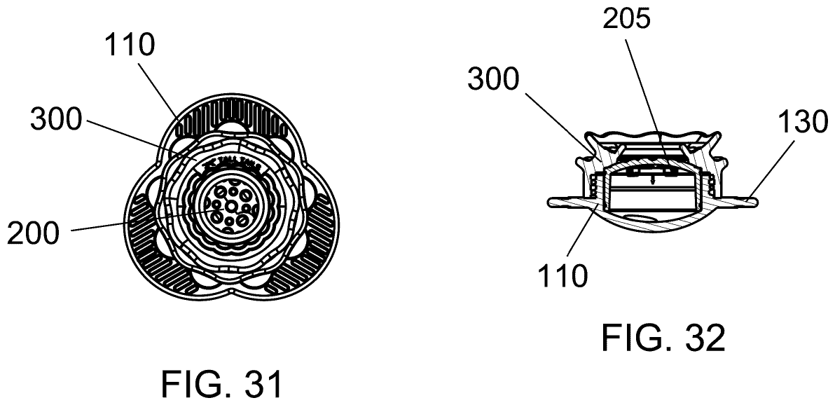

### Recess Above Inverted Insert (FIGS. 29-32)

Now referring to FIGS. 29-32, in which a pet toy formed by an arrangement of parts is shown. In this embodiment, the base 113 is used with insert 200 in its inverted orientation. In this orientation, there is a recess 205 between the inverted insert 200 and the top of the cover 300. The recess 205 is above the top of the inverted insert 200 and the opening defining portion 332. This recess 205 can contain pastes, liquid, or frozen solid treats, etc. This recess 205 can thus constitute a retention recess for holding the consumable.

### Shapes of the Various Parts

It will be appreciated that the various parts described herein can have different shapes and sizes than those depicted in the attached figures. For example, the pet toy is not limited to a flower shape and the base can lack a petal design but instead can have one or more paw engaging sections incorporated therein. Similarly, the cover is not limited to having a petal shape but can have many different shapes including a beehive (honeycomb) shape; an undulating top surface shape, etc. In all embodiments, the cover includes an opening or through-hole to permit the animal to access the consumable in the container 510. The invention is more broadly captured by the various arrangements of the different parts and the functionality provided by these parts.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A pet toy that is configured to facilitate controlled dispensing of a consumable to encourage extended engagement that supports calming, soothing, the pet toy comprising:
a base having a non-planar bottom surface to promote rocking of the base, the base having a first chamber defined therein that is open at a top of the base;
an insert that is removably received within the first chamber, the insert defining a second chamber for holding the consumable;
a consumable delivery member rotatably and at least partially disposed within the second chamber; and
a cover that is coupled to the base such that the cover abuts a top edge of the insert to retain the insert in place, the cover having a top opening through which the consumable delivery member protrudes;
wherein the consumable delivery member freely rotates relative to the insert and the cover to permit the consumable to be dispensed through the top opening.

2. The pet toy of claim 1, wherein the base has a curved center portion with an outer flange at least partially surrounding the curved center portion, with the curved center portion located below the outer flange.

3. The pet toy of claim 2, wherein the base has a first side wall that protrudes above the outer flange such that that the first chamber is defined by both the curved center portion and the first side wall.

4. The pet toy of claim 2, wherein the curved center portion has a convex bottom surface and a concave top surface that defines a bottom floor of the first chamber.

5. The pet toy of claim 3, wherein the first side wall includes outer threads formed along an outer surface thereof and the cover includes inner threads that threadingly engage the outer threads to couple the cover to the base.

6. The pet toy of claim 2, wherein a top surface of the outer flange includes surface modifying features.

7. The pet toy of claim 1, wherein the insert comprises a cup-shaped object defined by a curved bottom wall and a second side wall.

8. The pet toy of claim 1, wherein the insert is configured to only be inserted into the first chamber in a first rotational orientation and in combination with the base is configured to prevent counterclockwise and clockwise rotation of the insert relative to the base.

9. The pet toy of claim 1, wherein the base has a curved center portion with an outer flange at least partially surrounding the curved center portion, with the curved center portion located below the outer flange, the base further including a first side wall that protrudes above the outer flange such that that the first chamber is defined by both the curved center portion and the first side wall, wherein the first side wall includes at least one notch formed therein to permit access to the insert for removal thereof.

10. The pet toy of claim 1, wherein the consumable delivery member comprises a spherical shaped ball.

11. The pet toy of claim 7, wherein the base has a curved center portion with an outer flange at least partially surrounding the curved center portion, the curved bottom wall of the insert seating against the curved center portion of the base.

12. The pet toy of claim 7, wherein an outer surface of the curved bottom wall of the insert has surface modifying features formed therein.

13. The pet toy of claim 12, wherein the surface modifying features comprise protrusions or depressions.

14. The pet toy of claim 7, wherein the base has a curved center portion with an outer flange at least partially surrounding the curved center portion, the base having a first side wall that protrudes above the outer flange such that that the first chamber is defined by both the curved center portion and the side wall, wherein a top edge of the second side wall extends above a top edge of the first side wall.

15. The pet toy of claim 1, wherein the base has a curved center portion, an outer flange at least partially surrounding the curved center portion and a first side wall that protrudes above the outer flange such that that the first chamber is defined by both the curved center portion and the first side wall, wherein the cover has: 1) a bottom section that includes inner threads that threadingly engage outer threads formed along an outer surface of the first side wall; 2) an intermediate section that contacts and retains the insert in place; and 3) a top section that includes an opening defining portion that defines the top opening and prevents free removal of the consumable delivery member through the top opening, with a space formed between the opening defining portion and the consumable delivery member to allow for the consumable to coat the outer surface of the consumable delivery member and be presented for consumption.

16. The pet toy of claim 15, wherein the opening defining portion slopes inwardly.

17. The pet toy of claim 1, wherein the insert comprises a cup-shaped object defined by a curved bottom wall and a second side wall, the curved bottom wall including one or more protrusions that define a support structure for the consumable delivery member.

18. The pet toy of claim 1, wherein an outer surface of the insert includes a groove formed therein proximate to an open end of the insert to assist in removal of the insert from the base.

19. The pet toy of claim 1, wherein the base has an outer flange that defines a plurality of regions that extend radially outward from the cover and provide paw zones to allow areas for an animal to stabilize the pet toy and the plurality of regions provide zones for spreadables or pastes to expand a consumable experience of the animal.

20. The pet toy of claim 1, wherein the cover includes a valley region that surrounds the top opening and provides a zone for spreadables or pastes to expand consumable experiences.

21. The pet toy of claim 1, wherein the cover defines a surface area to create a lick zone that optimizes tongue contact to extend and to enhance the licking experience and includes ergonomic considerations to support various dog physiology.

22. The pet toy of claim 1, wherein the consumable comprises a liquid.

23. The pet toy of claim 1, wherein the cover has a trough extending circumferentially around the top opening, the trough being configured to hold an additional consumable.

24. The pet toy of claim 23, wherein the top opening is defined by a collar portion of the cover and the cover has a top outer perimeter wall with the trough being formed between the collar portion and the top outer perimeter wall.

25. The pet toy of claim 24, wherein the top outer perimeter wall has a height that is greater than a height of the collar portion.

26. The pet toy of claim 1, wherein the base further includes a bottom wall that defines the bottom surface and a first side wall, the first chamber being defined by both the bottom wall and the first side wall, wherein the first side wall includes at least one notch formed therein and being open along a top edge of the first side wall.

27. The pet toy of claim 26, wherein the base is formed of a flexible material and the at least one notch comprises a pair of notches located 180 degrees apart, the pair of notches defining a hinge that permits flexing of the base about the hinge for expelling and inserting the insert within the base.

28. A pet toy that is configured for dispensing of a consumable, the pet toy comprising:
a base having a non-planar bottom surface to promote rocking of the base, the base having a first chamber defined therein that is open at a top of the base and there is at least one through hole formed in the non-planar bottom surface;
an insert that is removably received within the first chamber, the insert defining a second chamber for holding the consumable, the insert comprising a cup-shaped object defined by a curved wall and an insert side wall, the curved wall of the insert closing off the first chamber, the at least one through hole defining an entrance into the second chamber through which the consumable can exit the second chamber and be dispensed; and
a cover that is coupled to the base such that the cover abuts the insert to retain the insert in place.

29. A pet toy that is configured for dispensing of a consumable, the pet toy comprising:
a base having a first chamber defined therein that is open at a top of the base and there is at least one through hole formed in a bottom surface of the base;
an insert that is positionable within the first chamber in either a first position or a second position, the insert defining a second chamber for holding the consumable, the insert comprising a cup-shaped object; and
a cover that is coupled to the base such that the cover abuts the insert to retain the insert in place in both the first and second positions of the insert;
wherein in the first position, an open end of the insert faces the cover and the consumable is dispensed through a top opening in the cover; and
wherein in the second position, the open end of the insert faces the base and a closed end of the insert closes off the top opening of the cover and the consumable is dispensed through the at least one through hole formed in the base.

30. The pet toy of claim 29, wherein in the second position, the consumable comprises kibble.

31. A pet toy comprising:
a disposable container holding a consumable within an interior chamber formed therein, the container having a bottom surface and an open top defined by a top edge, the open top being closed off by a removable first cover; and
a main cover that is detachably attached to the container such that the cover retains the container in place, the main cover having a top opening that is in communication with the interior chamber to permit the consumable to be dispensed through the top opening;
wherein main cover is a hollow structure including a bottom opening through which the container is inserted, the bottom surface of the container defining a ground contacting surface when the container is attached to the main cover.

32. The pet toy of claim 31, wherein the first cover comprises a foil cover.

33. The pet toy of claim 31, wherein the bottom surface of the container has a curved shape.

34. The pet toy of claim 31, wherein the main cover has an outer flange that extends radially outward from the bottom opening, the outer flange defining an outermost perimeter edge of the main cover, the outer flange being configured to contact a ground surface to limit a rocking motion of the pet toy.

35. The pet toy of claim 34, wherein the consumable comprises a solid food product.

36. The pet toy of claim 31, wherein the main cover has a trough extending circumferentially around the top opening.
